(19) United States
(12) Patent Application Publication
(10) Pub. No.: US 2024/0316954 A1
(43) Pub. Date: Sep. 26, 2024

(54) MEDIUM HEATING APPARATUS AND RECORDING APPARATUS

(71) Applicant: SEIKO EPSON CORPORATION, Tokyo (JP)

(72) Inventors: Kenichiro KANEKO, OKAYA-SHI (JP); Yohei SHIBATA, SHIOJIRI-SHI (JP)

(21) Appl. No.: 18/670,054

(22) Filed: May 21, 2024

(30) Foreign Application Priority Data
Mar. 23, 2023 (JP) 2023-084388

(51) Int. Cl. B41J 11/00; B08B 1/14; B08B 1/20; B08B 1/34; B41J 15/04; B41J 15/16; B41J 29/17

(52) U.S. Cl. CPC B41J 11/0022; B08B 1/14; B08B 1/20; B08B 1/34; B41J 15/046; B41J 15/16; B41J 29/17

(57) ABSTRACT

A medium heating apparatus includes a heating unit configured to heat a medium on which liquid was ejected, a winding unit configured to wind the medium heated by the heating unit, and a guide bar around which the medium is wound between the heating unit and the winding unit, the guide bar being configured to guide the medium to the winding unit. The heating unit includes a heat source facing a surface of the medium on which liquid was ejected, and a jetting unit configured to jet air to the surface of the medium on which liquid was ejected, and the guide bar is configured to make contact with the surface of the medium on which liquid was ejected, and configured to be rotatable.

The present application is based on, and claims priority from JP Application Serial Number 2023-084388, filed May 23, 2023, the disclosure of which is hereby incorporated by reference herein in its entirety.

### BACKGROUND

### 1. Technical Field

The present disclosure relates to a medium heating apparatus and a recording apparatus.

### 2. Related Art

JP-A-2019-30989 discloses a medium heating apparatus including a heating unit that heats a medium on which liquid has been ejected, a guide bar around which the heated medium is wound, and a winding unit that winds the medium guided by the guide bar.

In such a medium heating apparatus, vapor of liquid evaporated from the medium heated by the heating unit may adhere to the guide bar. This may cause condensation on the guide bar. If the droplets generated on the guide bar due to condensation become large, the medium may be contaminated and damaged due to the adhesion of the droplets to the medium.

### SUMMARY

A medium heating apparatus for solving the above-described problems includes a heating unit configured to heat a medium on which liquid was ejected, a winding unit configured to wind the medium heated by the heating unit, and a guide bar around which the medium is wound between the heating unit and the winding unit, the guide bar being configured to guide the medium to the winding unit. The heating unit includes a heat source facing a surface of the medium on which liquid was ejected, and a jetting unit configured to jet air to the surface of the medium on which liquid was ejected, and the guide bar is configured to make contact with the surface of the medium on which liquid was ejected, and configured to be rotatable.

A recording apparatus for solving the above-described problems includes a heating unit configured to heat a medium on which liquid was ejected, a winding unit configured to wind the medium heated by the heating unit, a guide bar around which the medium is wound between the heating unit and the winding unit, the guide bar being configured to guide the medium to the winding unit, and a recording unit configured to record an image on the medium by ejecting liquid to the medium. The heating unit includes a heat source facing a surface of the medium on which liquid was ejected, and a jetting unit configured to jet air to the surface of the medium on which liquid was ejected, and the guide bar is configured to make contact with the surface of the medium on which liquid was ejected, and configured to be rotatable.

### BRIEF DESCRIPTION OF THE DRAWINGS

FIG. 1 is a side view illustrating an example of a recording apparatus including a medium heating apparatus.

FIG. 2 is a front view of the recording apparatus.

FIG. 3 is a side view illustrating a modification of the recording apparatus.

FIG. 4 is a front view of the recording apparatus illustrated in FIG. 3.

FIG. 5 is a side view illustrating another modification of FIG. 3.

FIG. 6 is a front view of the recording apparatus illustrated in FIG. 5.

### DESCRIPTION OF EMBODIMENTS

An example of a recording apparatus including a medium heating apparatus is described below with reference to the drawings. The recording apparatus is an ink-jet printer that records images such as letters and photographs by ejecting ink, which is an example of liquid, to a medium such as sheets and fabric, for example.

### Recording Apparatus

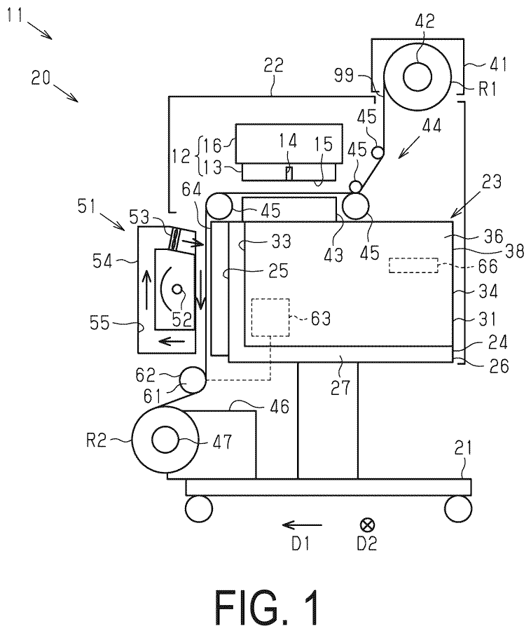

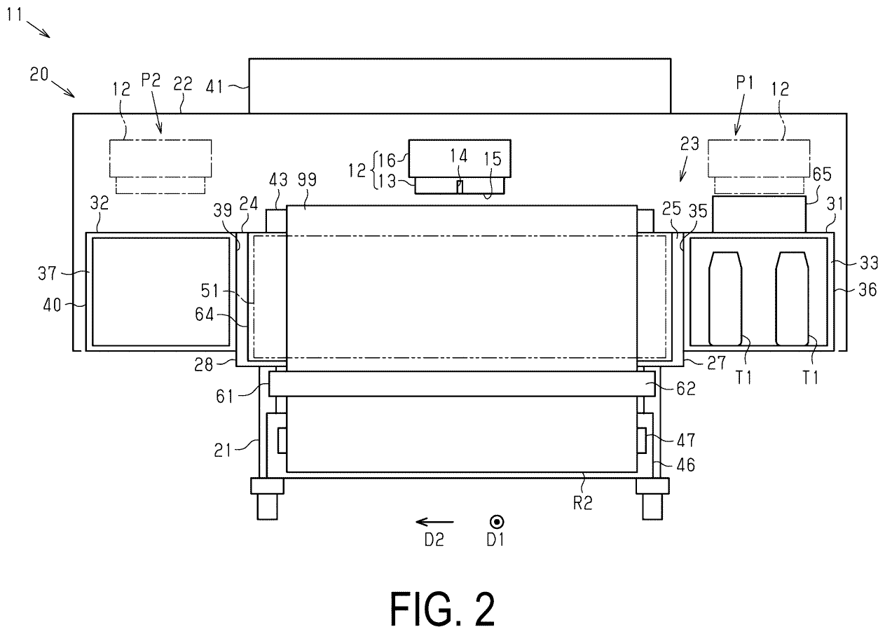

As illustrated in FIGS. 1 and 2, a recording apparatus 11 includes a recording unit 12. The recording unit 12 is configured to record an image on a medium 99. Specifically, the recording unit 12 records an image on the medium 99 by ejecting liquid to the medium 99. The recording unit 12 records an image on the medium 99 conveyed in a first direction D1. The first direction D1 is a direction from the rear side to the front side of the recording apparatus 11.

The recording unit 12 includes a head 13. The head 13 includes a nozzle surface 15 at which one or more nozzles 14 open. The nozzle surface 15 faces the medium 99. The head 13 ejects liquid from the nozzle 14.

The recording unit 12 includes a carriage 16. The carriage 16 is equipped with the head 13. In an example, the carriage 16 performs scanning with respect to the medium 99. Specifically, the carriage 16 moves in a second direction D2 different from the first direction D1. More specifically, the carriage 16 moves back and forth in the second direction D2 and the direction opposite to the second direction D2. In this manner, the head 13 can eject liquid over the width of the medium 99. Thus, the recording apparatus 11 is a serial printer. The recording apparatus 11 may be a line printer that can simultaneously eject liquid over the width of the medium 99.

The recording unit 12 is displaced between a maintenance position P1 and a cleaning position P2 through the back-and-forth movement in the second direction D2 and the direction opposite to the second direction D2. In an example case, the recording unit 12 is displaced from the maintenance position P1 to the cleaning position P2 through the movement in the second direction D2. The two recording units 12 indicated with the single dotted line in FIG. 2 are located at the maintenance position P1 and the cleaning position P2.

At the maintenance position P1, maintenance of the recording unit 12 is performed by a maintenance unit 65 described later. Specifically, the maintenance position P1 is a position where the recording unit 12 is close to the maintenance unit 65. At the cleaning position P2, the recording unit 12 is cleaned by the user, for example. Specifically, the cleaning position P2 is a position where the user can easily access the recording unit 12.

The recording apparatus 11 includes a medium heating apparatus 20. The medium heating apparatus 20 is configured to heat the medium 99 on which the liquid has been ejected. The medium heating apparatus 20 dries the medium 99 by heating the medium 99. When the medium 99 is dried, the image recorded on the medium 99 is fixed. At the medium heating apparatus 20, the vapor of the liquid ejected to the medium 99 is generated from the medium 99 when the medium 99 is heated. The vapor contains water, solvent and the like that make up liquid.

### Medium Heating Apparatus

The medium heating apparatus 20 includes a leg part 21. The leg part 21 is in contact with the installation surface where the medium heating apparatus 20 is installed. The medium heating apparatus 20 includes a housing 22. The housing 22 houses the recording unit 12, for example. The medium heating apparatus 20 includes a frame 23. The frame 23 is composed of a sheet metal. The frame 23 is attached to the leg part 21. The frame 23 is located above the leg part 21. The housing 22 is attached to the frame 23. The frame 23 supports various components provided in the medium heating apparatus 20.

The frame 23 includes a main frame 24. The main frame 24 is a frame that houses a control unit 66 described later. The main frame 24 defines the space where the control unit 66 is located. The main frame 24 is attached to the leg part 21.

The main frame 24 includes a plurality of surfaces. The main frame 24 includes a front surface 25, a rear surface 26, a first side surface 27, and a second side surface 28, for example. The front surface 25 is a surface that faces the front of the medium heating apparatus 20. In an example, the front surface 25 faces the first direction D1. The rear surface 26 is a surface opposite to the front surface 25. The rear surface 26 faces opposite the first direction D1. The first side surface 27 is a surface coupled with the front surface 25 and the rear surface 26. In an example, the first side surface 27 faces opposite the second direction D2. The second side surface 28 is a surface coupled with the front surface 25 and the rear surface 26. The second side surface 28 faces opposite the first side surface 27. The second side surface 28 faces the second direction D2.

The frame 23 includes one or more sub frames. In an example, the frame 23 includes two sub frames. For example, the frame 23 includes a first sub frame 31 and a second sub frame 32. The sub frame is attached to the main frame 24. The sub frame is arranged with the main frame 24 in the second direction D2. Specifically, the first sub frame 31, the main frame 24, and the second sub frame 32 are arranged in this order in the second direction D2. The first sub frame 31 and the second sub frame 32 sandwich the main frame 24 in the second direction D2.

The first sub frame 31 is attached to the main frame 24. In an example, the first sub frame 31 is attached to the first side surface 27. The first sub frame 31 is a frame that ensures the maintenance position P1, for example. The position on the upper side of the first sub frame 31 is the maintenance position P1. The first sub frame 31 supports the maintenance unit 65.

The first sub frame 31 houses a waste liquid tank T1. The waste liquid tank T1 is coupled to the maintenance unit 65. The waste liquid tank T1 stores the liquid received by the maintenance unit 65. The waste liquid tank T1 is replaceable for the first sub frame 31.

The first sub frame 31 includes a plurality of surfaces. The first sub frame 31 includes a first front surface 33, a first rear surface 34, a first opposite side surface 35, and a first non-opposite side surface 36, for example. The first front surface 33 is a surface that faces the front of the medium heating apparatus 20. In an example, the first front surface 33 faces the first direction D1. The first rear surface 34 is a surface that faces opposite the first front surface 33. The first rear surface 34 faces opposite the first direction D1. The first opposite side surface 35 is a side surface coupled with the first front surface 33 and the first rear surface 34. The first opposite side surface 35 faces the main frame 24. Specifically, the first opposite side surface 35 faces the first side surface 27. The first opposite side surface 35 makes contact with the first side surface 27. In an example, the first opposite side surface 35 faces the second direction D2. The first non-opposite side surface 36 is a side surface coupled with the first front surface 33 and the first rear surface 34. The first non-opposite side surface 36 faces opposite the first opposite side surface 35. The first non-opposite side surface 36 does not face the main frame 24. The first non-opposite side surface 36 faces opposite the second direction D2.

The second sub frame 32 is attached to the main frame 24. In an example, the second sub frame 32 is attached to the second side surface 28. The second sub frame 32 is a frame that ensures the cleaning position P2, for example. The position on the upper side of the second sub frame 32 is the cleaning position P2.

The second sub frame 32 includes a plurality of surfaces. The second sub frame 32 includes a second front surface 37, a second rear surface 38, a second opposite side surface 39, and a second non-opposite side surface 40, for example. The second front surface 37 is a surface that faces the front of the medium heating apparatus 20. In an example, the second front surface 37 faces the first direction D1. The second rear surface 38 is a surface that faces opposite the second front surface 37. The second rear surface 38 faces opposite the first direction D1. The second opposite side surface 39 is a side surface coupled with the second front surface 37 and the second rear surface 38. The second opposite side surface 39 faces the main frame 24. Specifically, the second opposite side surface 39 faces the second side surface 28. The second opposite side surface 39 makes contact with the second side surface 28. In an example, the second opposite side surface 39 faces the opposite direction of the second direction D2. The second non-opposite side surface 40 is a side surface coupled with the second front surface 37 and the second rear surface 38. The second non-opposite side surface 40 faces opposite the second opposite side surface 39. The second non-opposite side surface 40 does not face the main frame 24. The second non-opposite side surface 40 faces the second direction D2.

As illustrated in FIG. 1, the medium heating apparatus 20 may include a feeding unit 41. The feeding unit 41 is configured to feed the medium 99. Specifically, the feeding unit 41 feeds the medium 99 before the recording. The feeding unit 41 is attached to the frame 23. The feeding unit 41 is attached to the main frame 24, for example. The feeding unit 41 includes a feeding shaft 42. The feeding shaft 42 rotatably supports a roll R1 composed of the wound medium 99. As the feeding shaft 42 rotates, the medium 99 is fed from the roll R1. Thus, in an example, the medium heating apparatus 20 heats the medium 99 fed from the feeding unit 41. The medium heating apparatus 20 may heat the medium 99 fed from another apparatus.

The medium heating apparatus 20 includes a supporting unit 43. The supporting unit 43 supports the medium 99. The supporting unit 43 faces the nozzle surface 15. Thus, the supporting unit 43 supports the medium 99 to be subjected to the recording by the recording unit 12. Specifically, the supporting unit 43 supports a portion of the medium 99 to be subjected to the recording by the recording unit 12. The supporting unit 43 is attached to the main frame 24, for example. The supporting unit 43 is located on the upper side of the main frame 24.

The medium heating apparatus 20 includes a conveyance unit 44. The conveyance unit 44 is configured to convey the medium 99. The conveyance unit 44 conveys the medium 99 fed from the feeding unit 41. The conveyance unit 44 conveys in the first direction D1 the medium 99 located on the supporting unit 43. The conveyance unit 44 conveys downward the medium 99 recorded by the recording unit 12. Specifically, the conveyance unit 44 conveys the medium 99 such that the medium 99 passes through the upper side of the main frame 24 and the front side of the main frame 24. The conveyance unit 44 includes one or more rollers 45. The roller 45 makes contact with the medium 99. As the roller 45 rotates, the medium 99 is conveyed.

The medium heating apparatus 20 includes a winding unit 46. The winding unit 46 is configured to wind the medium 99. Specifically, the winding unit 46 winds the recorded medium 99. More specifically, the winding unit 46 winds the medium 99 heated by a heating unit 51 described later. The winding unit 46 is attached to the leg part 21, for example. The winding unit 46 includes a winding shaft 47. The winding shaft 47 rotatably supports a roll R2 composed of the wound medium 99. As the winding shaft 47 rotates, the medium 99 is wound around the roll R2.

The medium heating apparatus 20 includes the heating unit 51. The heating unit 51 is configured to heat the medium 99. The heating unit 51 heats the medium 99 conveyed by the conveyance unit 44. Specifically, the heating unit 51 heats a portion of the medium 99 that has been subjected to recording of the recording unit 12 but is before wound by the winding unit 46.

The heating unit 51 is attached to the main frame 24. The heating unit 51 is located on the front side of the main frame 24. Specifically, the heating unit 51 faces the front surface 25. The heating unit 51 heats the medium 99 that passes between the heating unit 51 and the main frame 24. Specifically, in an example, the heating unit 51 heats a portion of the medium 99 that is conveyed downward.

The heating unit 51 overlaps the housing 22 as viewed in the vertical direction. In an example, a part of the heating unit 51 overlaps the housing 22 as viewed in the vertical direction. In this manner, in comparison with the case where the heating unit 51 does not overlap the housing 22 as viewed in the vertical direction, the protruding amount of the heating unit 51 protruding forward from the housing 22 is reduced. In this manner, the footprint of the medium heating apparatus 20 is reduced. Normally, the user operates the medium heating apparatus 20 from the front side of the medium heating apparatus 20. Therefore, the reduction of the protruding amount of the heating unit 51 with respect to the housing 22 makes the user operation of the medium heating apparatus 20 easier.

The heating unit 51 includes a heat source 52. The heat source 52 is configured to generate heat. The heat source 52 faces the surface of the medium 99 on which liquid has been ejected. Thus, the heat source 52 heats the surface of the medium 99 on which liquid has been ejected. In an example, the heat source 52 heats the medium 99 by means of radiant heat. The heat source 52 is an infrared ray heater, for example. The heat source 52 emits an infrared ray toward the medium 99. As the heat source 52 heats the medium 99, the medium 99 is dried.

The heating unit 51 includes a jetting unit 53. The jetting unit 53 is a fan, for example. The jetting unit 53 is configured to jet air to the medium 99. Specifically, the jetting unit 53 jets air to the surface of the medium 99 on which liquid has been ejected. More specifically, the jetting unit 53 jets air such that the air flows downward along the medium 99. Thus, the air jetted to the medium 99 flows downward along the surface of the medium 99 on which liquid has been ejected. In this manner, the vapor on the medium 99 flows downward, thus facilitating the drying of the medium 99. In addition, the risk of occurrence of the situation where the air heated by the heating unit 51, the vapor generated from the medium 99 or the like flows to the upper side, i.e., to the inside of the housing 22 is reduced. That is, the risk of high temperature in the housing 22 or high humidity in the housing 22 is reduced. Thus, the risk of deterioration in recording quality is reduced.

The heating unit 51 includes a case 54. The case 54 houses the heat source 52 and the jetting unit 53. The case 54 opens toward the medium 99. Specifically, the case 54 opens toward the front surface 25.

In the case 54, a circulation channel 55 may be formed. The circulation channel 55 is a channel for circulating the air heated by the heat source 52. The circulation channel 55 extends to surround the heat source 52. The jetting unit 53 is located in the circulation channel 55. In the heating unit 51, the air jetted by the jetting unit 53 circulates by flowing over the medium 99 and through the circulation channel 55. More specifically, the air circulates as indicated with the arrow in FIG. 1. In this manner, the heating efficiency of the medium 99 is improved.

The medium heating apparatus 20 includes a guide bar 61. The guide bar 61 is configured to guide the medium 99 to the winding unit 46. The medium 99 is wound around the guide bar 61. Specifically, the medium 99 is wound around the guide bar 61 between the heating unit 51 and the winding unit 46. Thus, the medium 99 heated by the heating unit 51 is wound around the guide bar 61. As such, the guide bar 61 makes contact with a portion of the medium 99 that has been heated by the heating unit 51 but is before wound by the winding unit 46. The medium 99 is guided downward by the guide bar 61. In an example, the guide bar 61 is located immediately below the heating unit 51.

The guide bar 61 includes a peripheral surface 62. The peripheral surface 62 is a surface that makes contact with the medium 99. With the medium 99 wound around the peripheral surface 62, the guide bar 61 guides the medium 99.

The guide bar 61 makes contact with the surface of the medium 99 on which liquid has been ejected. As such, the guide bar 61 is exposed to air and vapor with high temperature flowing along the medium 99 from the heating unit 51. As a result, the vapor adheres to the peripheral surface 62. Therefore, there is a risk of occurrence of condensation on the peripheral surface 62. If the droplets generated on the peripheral surface 62 due to condensation become large, the medium 99 may be contaminated and damaged by the adhesion of the droplets on the medium 99. In addition, the droplets dropped from the guide bar 61 to the floor may contaminate and damage the floor.

The guide bar 61 is configured to be rotatable. As the guide bar 61 rotates, the medium 99 makes contact with the peripheral surface 62 over the whole circumference. In this manner, before the droplet generated on the peripheral surface 62 due to condensation becomes large, it is wiped off by the medium 99. Since the medium 99 wipes off micro droplets adhered on the peripheral surface 62, the risk of contamination and damage of the medium 99 is small.

The guide bar 61 is configured to actively rotate with respect to the medium 99. The guide bar 61 may be configured to rotate to follow the medium 99. The guide bar 61 may rotate through friction with the medium 99 as the medium 99 is conveyed, for example. Specifically, the guide bar 61 may rotate through friction with the medium 99 as the medium 99 is wound by the winding unit 46.

The medium heating apparatus 20 includes a driving unit 63. The driving unit 63 is coupled with the guide bar 61. The driving unit 63 is driven to rotate the guide bar 61. The driving unit 63 is a motor, for example. The driving unit 63 is attached to the main frame 24, for example.

The driving unit 63 may rotate the guide bar 61 at a rotational speed that matches the conveyance speed of the medium 99. In this manner, the friction between the medium 99 and the guide bar 61 is reduced. The conveyance speed of the medium 99 is the rotational speed of the roller 45. The driving unit 63 may rotate the guide bar 61 at a rotational speed higher than the conveyance speed of the medium 99. In this manner, the area of the peripheral surface 62 where the medium 99 makes contact per unit time increases. In this case, the medium 99 quickly wipes off the peripheral surface 62.

The medium heating apparatus 20 may include a heat shielding member 64. The heat shielding member 64 is configured to shield the heat of the heating unit 51. Specifically, the heat shielding member 64 shields the heat applied from the heating unit 51 to the main frame 24. The heat shielding member 64 is located between the heating unit 51 and the main frame 24. The heat shielding member 64 is attached to the main frame 24. The heat shielding member 64 is located along the front surface 25. The heat shielding member 64 faces the heating unit 51. The medium 99 passes through the heat shielding member 64 and the heating unit 51.

As illustrated in FIG. 2, the medium heating apparatus 20 may include the maintenance unit 65. The maintenance unit 65 performs maintenance of the recording unit 12 located at the maintenance position P1. In an example, the maintenance unit 65 performs maintenance of the recording unit 12 by receiving liquid of flushing, cleaning and the like from the recording unit 12. The flushing is an operation of appropriately ejecting the liquid from the nozzle 14. The flushing reduces the risk of clogging of the nozzle 14. The cleaning is an operation of ejecting the liquid from the nozzle 14. The cleaning ejects foreign matters together with the liquid from the nozzle 14. The maintenance unit 65 ejects the liquid from the nozzle 14 by suctioning it in the state where it is in contact with the head 13. The liquid received by the maintenance unit 65 flows to the waste liquid tank T1.

As illustrated in FIG. 1, the medium heating apparatus 20 includes the control unit 66. The control unit 66 controls the driving unit 63. The control unit 66 may generally control the medium heating apparatus 20. Specifically, the control unit 66 may control the feeding unit 41, the conveyance unit 44, the winding unit 46, the heating unit 51, the maintenance unit 65 and the like. The control unit 66 may further control the recording unit 12.

The control unit 66 may be composed of one or more processors that execute various processes in accordance with a computer program. The control unit 66 may be composed of one or more dedicated hardware circuits such as an application-specific integrated circuit that executes at least some of various processes. The control unit 66 may be composed of a circuit including a combination of a processor and a hardware circuit. The processor includes a CPU, and a memory such as a RAM and a ROM. The memory stores program codes or commands configured to cause the CPU to execute processes. The memory, i.e., a computer readable medium, includes any type of readable mediums that are accessible by general-purpose or dedicated computers.

The control unit 66 may control the driving unit 63 based on the amount of liquid ejected to the medium 99. The control unit 66 controls the driving unit 63 based on the amount of liquid ejected to the medium 99 by the recording unit 12, for example. The control unit 66 determines the amount of liquid ejected from the recording unit 12 to the medium 99 with reference to the recording data. The recording data is a data that is transmitted to the recording unit 12 at the time of the recording on the medium 99. The recording data includes image data representing the image to be recorded, duty data representing the amount of liquid to be ejected by the recording unit 12, and the like.

The control unit 66 controls the rotational speed of the guide bar 61 by controlling the driving unit 63. Since the guide bar 61 makes contact with the surface of the medium 99 on which the liquid has been ejected, it may reduce the quality of the image recorded on the medium 99. In view of this, when the amount of liquid ejected to the medium 99 is normal, it is desirable for the control unit 66 to reduce the friction of the medium 99 and the guide bar 61 by rotating the guide bar 61 at a speed matching the conveyance speed of the medium 99. However, when the amount of liquid ejected to the medium 99 becomes large, the amount of vapor that adheres to the peripheral surface 62 becomes large. In this case, the growth speed of droplets generated due to condensation increases. In view of this, when the amount of liquid ejected to the medium 99 is large, the droplet can be wiped off with the medium 99 before the droplet becomes large by controlling the driving unit 63 with the control unit 66 so as to increase the rotational speed of the guide bar 61, and thus the risk of contamination and damage of the medium 99 is reduced.

The control unit 66 may control the driving unit 63 based on detection results of a detection sensor that makes contact with the medium 99 to detect the amount of liquid ejected to the medium 99. The control unit 66 may control the driving unit 63 based on detection results of a detection sensor that detects the amount of vapor flowing from the heating unit 51 toward the guide bar 61.

### Operations and Effects

Next, operations and effects of the above-mentioned examples are described.
(1) The guide bar 61 is configured to be rotatable by making contact with the surface of the medium 99 on which the liquid has been ejected. The air jetted by the jetting unit 53 to the medium 99 flows along the medium 99 and touches the guide bar 61. As a result, the vapor of the liquid evaporated from the medium 99 adheres to the guide bar 61, and condensation occurs on the guide bar 61. With the above-mentioned configuration, as the guide bar 61 rotates, the medium 99 wound around the guide bar 61 makes contact with the guide bar 61 over the whole circumference. In this manner, before the droplet condensing on the guide bar 61 becomes large, it is wiped off by the medium 99. Specifically, while the droplet condensing on the guide bar 61 is small, the droplet is wiped off by the medium 99. As long as the droplet is small, it is not noticeable even when absorbed by the medium 99. Thus, the risk of contamination and damage of the medium 99 due to droplets generated on the guide bar 61 due to condensation is reduced.
(2) The control unit 66 controls the driving unit 63 based on the amount of liquid ejected to the medium 99. The greater the amount of liquid ejected to the medium 99, the greater the amount of vapor that adheres on the guide bar 61. As a result, the droplets generated on the guide bar 61 due to condensation are likely to be enlarged. In view of this, with the above-mentioned configuration, the droplets are wiped off by the medium 99 before the droplets generated on the guide bar 61 due to condensation become large by increasing the rotational speed of the guide bar 61 as the amount of liquid ejected to the medium 99 increases, for example.

### Modifications

The above-mentioned examples may be modified as follows for implementation. The above-mentioned examples and the following modifications may be combined for implementation insofar as they are not technically inconsistent.

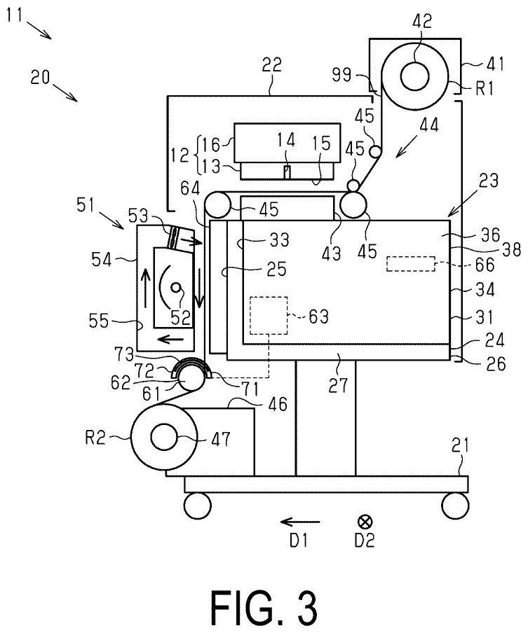

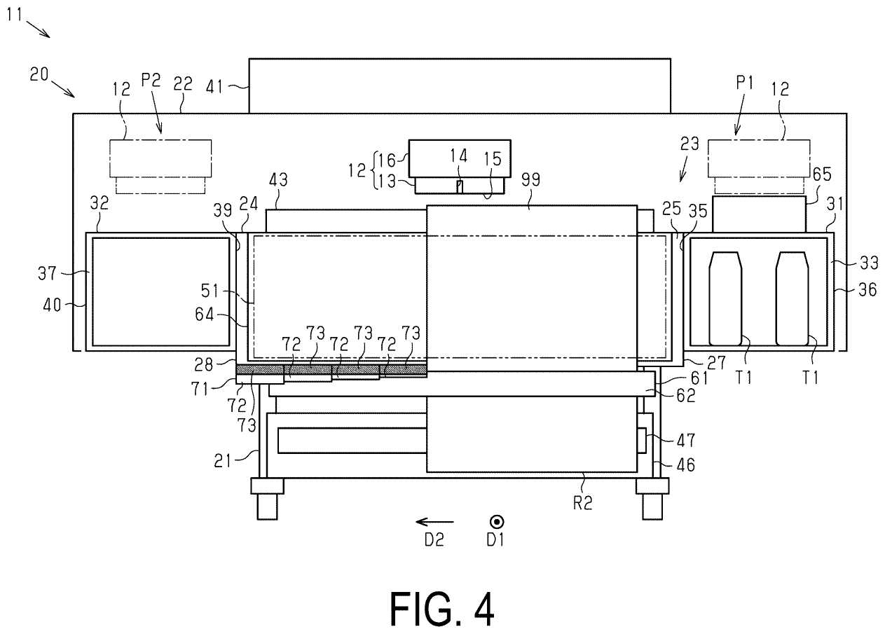

As illustrated in FIGS. 3 and 4, the medium heating apparatus 20 may include a cover member 71. The cover member 71 is a member that covers the guide bar 61. Specifically, the cover member 71 covers the portion of the guide bar 61 where at least the vapor due to the heating unit 51 adheres. Is this modification, the cover member 71 covers the guide bar 61 from above. The cover member 71 is located between the heating unit 51 and the guide bar 61. The cover member 71 is attached to the guide bar 61, for example.

The cover member 71 is configured to move along the guide bar 61. Specifically, the cover member 71 is configured to slide in the second direction D2. The cover member 71 is configured to manually slide, for example.

The cover member 71 is configured to be extendable and retractable in the second direction D2. The cover member 71 is composed of a plurality of couplers 72, for example. One coupler 72 of the plurality of couplers 72 slides with respect to another coupler 72, and thus the cover member 71 extends and retracts.

The medium heating apparatus 20 may heat the mediums 99 with different widths in some situation. When heating the medium 99 with a small width, the guide bar 61 has a portion around which the medium 99 is wound and a portion around which the medium 99 is not wound. In the guide bar 61, the vapor adheres on the portion around which the medium 99 is not wound, as on the portion around which the medium 99 is wound. If condensation occurs at the portion around which the medium 99 is not wound in the guide bar 61, the medium 99 cannot wipe off the droplets. Conversely, by sliding the cover member 71 in the second direction D2 in accordance with the width of the medium 99, the cover member 71 covers the portion around which the medium 99 is not wound in the guide bar 61. In this manner, the risk of occurrence of condensation due to the vapor adhering on the portion around which the medium 99 is not wound in the guide bar 61 is reduced. Thus, the risk of contamination and damage of the floor due to droplets generated at the peripheral surface 62 due to condensation and dropped to the guide bar 61 is reduced.

The cover member 71 may include an absorbing material 73. The absorbing material 73 is configured to absorb liquid. The absorbing material 73 is a sponge, for example. The absorbing material 73 is attached to the coupler 72. When the coupler 72 covers the guide bar 61, vapor adheres on the coupler 72. As such, there is a risk of occurrence of condensation on the cover member 71. The absorbing material 73 absorbs droplets generated due to condensation. In this manner, the risk of dropping of droplets generated on the cover member 71 due to condensation is reduced.

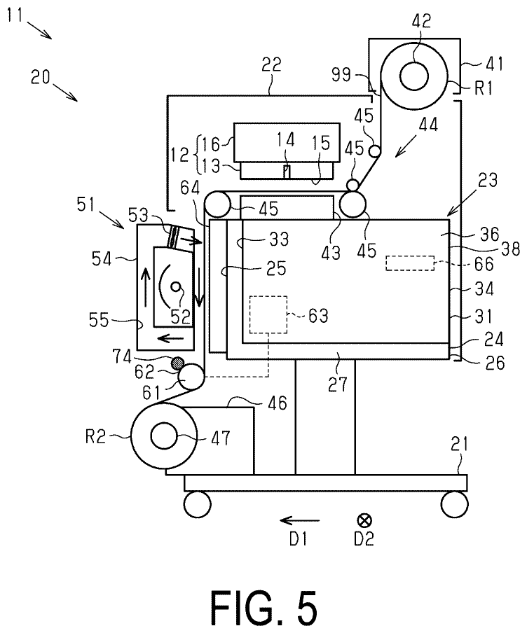

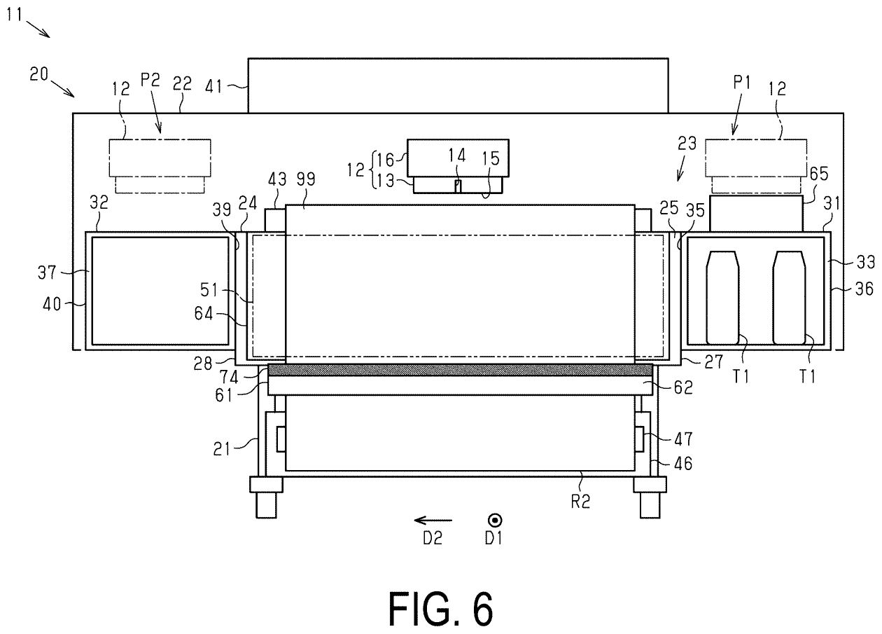

As illustrated in FIGS. 5 and 6, the medium heating apparatus 20 may include an absorbing roller 74. The absorbing roller 74 is configured to make contact with the guide bar 61. The absorbing roller 74 is configured to absorb liquid. The absorbing roller 74 is a sponge roller, for example.

The absorbing roller 74 is configured to make contact with the portion of the guide bar 61 that makes contact with the medium 99 over its entire length in the second direction D2. The absorbing roller 74 may be configured to be rotatable. The absorbing roller 74 may be configured to rotate to follow, or rotate actively. Specifically, the absorbing roller 74 may be configured to rotate through friction with the guide bar 61, or rotate by means of a motor.

The absorbing roller 74 makes contact with the peripheral surface 62 over the whole circumference as the guide bar 61 rotates. In this manner, the absorbing roller 74 can wipe off droplets generated on the peripheral surface 62 due to condensation. By wiping off the peripheral surface 62 with the absorbing roller 74 in addition to the wiping of the peripheral surface 62 with the medium 99, the risk of enlarging the droplets generated on the peripheral surface 62 is reduced.

The liquid ejected by the recording unit 12 is not limited to ink, but may be liquid in which particles of functional materials are dispersed or mixed, or the like, for example. For example, the recording unit 12 may eject liquid containing materials such as electrode materials or pixel materials dispersed or dissolved therein for use in manufacture of liquid crystal displays, electroluminescence displays, surface-emitting displays, and the like.

### Technical Ideas

The following describes technical ideas and operational effects that are derived from the above-described examples and modifications.

(A) A medium heating apparatus includes a heating unit configured to heat a medium on which liquid was ejected, a winding unit configured to wind the medium heated by the heating unit, and a guide bar around which the medium is wound between the heating unit and the winding unit, the guide bar being configured to guide the medium to the winding unit. The heating unit includes a heat source facing a surface of the medium on which liquid was ejected, and a jetting unit configured to jet air to the surface of the medium on which liquid was ejected, and the guide bar is configured to make contact with the surface of the medium on which liquid was ejected, and configured to be rotatable.

The air jetted by the jetting unit to the medium flows along the medium to touch the guide bar. As a result, the vapor of the liquid evaporated from the medium adheres to the guide bar, and condensation occurs on the guide bar. With the above-mentioned configuration, as the guide bar rotates, the medium wound around the guide bar makes contact with the guide bar over the whole circumference. In this manner, the droplet condensing on the guide bar is wiped off by the medium before it becomes large. Specifically, while the droplet condensing on the guide bar is small, the medium wipes off the droplet. As long as the droplet is small, it is not noticeable even when absorbed by the medium. Thus, the risk of contamination and damage of the medium due to the droplets generated on the guide bar due to condensation is reduced.

(B) The medium heating apparatus may further include a driving unit configured to rotate the guide bar, and a control unit configured to control the driving unit based on an amount of liquid ejected to the medium.

The larger the amount of liquid ejected to the medium, the larger the amount of vapor that adheres on guide bar. As such, the droplets generated on the guide bar due to condensation are likely to become large. In view of this, with the above-mentioned configuration, the droplets generated on the guide bar due to condensation are wiped off with the medium before the droplets become large by increasing the rotational speed of the guide bar as the amount of liquid ejected to the medium increases, for example.

(C) The medium heating apparatus may further include a cover member configured to cover the guide bar, and the cover member may be configured to move along the guide bar.

The medium heating apparatus may heat mediums with different widths in some situation. When heating a medium with a small width, the guide bar has a portion around which the medium is wound and a portion around which the medium is not wound. Vapor adheres on the portion around which medium is not wound in the guide bar, as on the portion around which the medium is wound. If condensation occurs at the portion around which the medium is not wound in the guide bar, the medium cannot wipe off the droplets. In view of this, with the above-mentioned configuration, the cover member covers the portion around which the medium is not wound in the guide bar, and thus the risk of occurrence of condensation on the portion around which the medium the portion is not wound in the guide bar is reduced.

(D) In the medium heating apparatus, the cover member may include an absorbing material configured to absorb liquid.

When the cover member covers the guide bar, vapor may adhere on the cover member. As such, there is a risk of occurrence of condensation on the cover member. With the above-mentioned configuration, the absorbing material can absorb the droplets generated on the cover member due to condensation.

(E) The medium heating apparatus may further include an absorbing roller configured to absorb liquid by making contact with the guide bar.

With the above-mentioned configuration, the absorbing roller, in addition to the medium, can wipe off the droplets generated on the guide bar due to condensation. In this manner, the risk of enlarging the droplets generated on the guide bar due to condensation is reduced.

(F) A recording apparatus includes a heating unit configured to heat a medium on which liquid was ejected, a winding unit configured to wind the medium heated by the heating unit, a guide bar around which the medium is wound between the heating unit and the winding unit, the guide bar being configured to guide the medium to the winding unit, and a recording unit configured to record an image on the medium by ejecting liquid to the medium. The heating unit includes a heat source facing a surface of the medium on which liquid was ejected, and a jetting unit configured to jet air to the surface of the medium on which liquid was ejected, and the guide bar is configured to make contact with the surface of the medium on which liquid was ejected, and configured to be rotatable.

The above-mentioned configuration can achieve the same effects as those of the above-described medium heating apparatus.

What is claimed is:

1. A medium heating apparatus comprising:
a heating unit configured to heat a medium on which liquid was ejected;
a winding unit configured to wind the medium heated by the heating unit; and
a guide bar around which the medium is wound between the heating unit and the winding unit, the guide bar being configured to guide the medium to the winding unit, wherein
the heating unit includes:
a heat source facing a surface of the medium on which liquid was ejected, and
a jetting unit configured to jet air to the surface of the medium on which liquid was ejected, and
the guide bar is configured to make contact with the surface of the medium on which liquid was ejected, and configured to be rotatable.

2. The medium heating apparatus according to claim 1, further comprising:
a driving unit configured to rotate the guide bar; and
a control unit configured to control the driving unit based on an amount of liquid ejected to the medium.

3. The medium heating apparatus according to claim 1, further comprising a cover member configured to cover the guide bar, wherein
the cover member is configured to move along the guide bar.

4. The medium heating apparatus according to claim 3, wherein the cover member includes an absorbing material configured to absorb liquid.

5. The medium heating apparatus according to claim 1, further comprising an absorbing roller configured to absorb liquid by making contact with the guide bar.

6. A recording apparatus comprising:
a heating unit configured to heat a medium on which liquid was ejected;
a winding unit configured to wind the medium heated by the heating unit;
a guide bar around which the medium is wound between the heating unit and the winding unit, the guide bar being configured to guide the medium to the winding unit; and
a recording unit configured to record an image on the medium by ejecting liquid to the medium, wherein
the heating unit includes:
a heat source facing a surface of the medium on which liquid was ejected, and
a jetting unit configured to jet air to the surface of the medium on which liquid was ejected, and
the guide bar is configured to make contact with the surface of the medium on which liquid was ejected, and configured to be rotatable.
